(19) United States
(12) Patent Application Publication
(10) Pub. No.: US 2007/0047030 A1
(43) Pub. Date: Mar. 1, 2007

(54) Method for controlling a printing presses

(75) Inventors: Michael Schonert, Augsburg (DE); Alfons Schuster, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/512,659

(22) Filed: Aug. 30, 2006

(30) Foreign Application Priority Data
Aug. 31, 2005 (DE) 10 2005 041 179.7

(51) Int. Cl. H04N 1/46

(52) U.S. Cl. 358/504

(57) ABSTRACT

The method for controlling a printing process in a printing press by means of cut register control, ink register control or ink density control includes the steps of measuring a printed image with a sensor to determine an actual characteristic value of the printed image, determining a prepress-based desired characteristic value for the printed image from prepress print image data by taking into account data about characteristics of the sensor, comparing the actual characteristic value of the printed image with the prepress-based desired characteristic value thereby acquiring a control deviation, and determining an actuating signal based on the control deviation for adjusting the printing process.

### BACKGROUND OF THE INVENTION

The invention relates to a method for controlling printing processes.

The control of printing processes, such as cut register control, ink register control or ink density control, is normally carried out by using print control marks printed onto the printed product, which are measured with the aid of sensors. Actual values determined from the print control marks are compared with desired values for the print control marks, in order to determine, on the basis of this comparison, actuating signals for the printing process to be regulated. Print control marks of this type, which are printed onto the printed product outside the actual printed image or subject, are disruptive in particular in newspaper printing, since in newspaper printing the printed product is not trimmed and, accordingly, the print control marks are visible in the end product. Therefore there is a need for control methods for printing processes which operate without such print control marks and accordingly mark-free.

DE 42 37 004 C2 discloses a control method operating mark-free for controlling the ink density in a printed product. For this purpose, the printed image from the printed product is measured directly with sensors. In this case, actual values determined are compared with desired values which are based on image data or prepress data.

U.S. Pat. No. 6,779,454 discloses a method likewise operating mark-free for cut register control on a press, wherein prepress-based desired values are also used for the control of the printing process.

In the mark-free control of printing processes by using prepress-based desired values, large quantities of data have to be processed, depending on the resolution of the prepress data. The efficiency of the control method suffers therefrom. If use is made of prepress data having a lower resolution, then the achievable control accuracy suffers therefrom.

### SUMMARY OF THE INVENTION

Therefore, an object of the present invention is to provide a novel a method for controlling printing processes.

According to a preferred embodiment of the invention, a method for controlling a printing process in a printing press by means of cut register control, ink register control or ink density control comprises the steps of measuring a printed image with at least one sensor thereby determining at least one actual characteristic value of the printed image; determining at least one prepress-based desired characteristic value for the printed image from prepress print image data by taking into account data about characteristics of the at least one sensor; comparing the at least one actual characteristic value of the printed image with the at least one prepress-based desired characteristic value thereby acquiring a control deviation; and determining an actuating signal based on the control deviation for adjusting the printing process.

Thus, in the control, actual values determined by sensors are compared with desired values which are adapted to the characteristics of the sensors used. Accordingly, in order to determine the prepress-based desired characteristic values, use is made only of those data from the prepress print image data which can be determined in the printed image by the sensors during operation. In this way, the quantity of data to be handled can be reduced considerably but without impairing the achievable control accuracy.

Preferably, each prepress-based desired characteristic value is determined from the prepress print image data, from data about the characteristics of the sensor and from data about the characteristics of the printing process.

A desired printed image determined by means of prepress print image data may be converted into an intermediate image while taking into account the characteristics of the respective sensor and the characteristics of the printing process, the respective desired characteristic value for the control being determined on the basis of the intermediate image. In this case, the characteristics of the respective sensor that are used comprise at least one of a gray scale resolution, a color step resolution, a spectral sensitivity, a geometric resolution and a measuring speed of the sensor. In this case, the characteristic of the printing process that is used is the speed of the printing process.

Preferred developments of the invention emerge from the dependent claims and the following description.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary preferred embodiment of the invention will be explained in more detail with reference to the drawing, in which:

FIG. 1 is a schematic block diagram illustrating a preferred embodiment of the method according to the invention.

### DETAILED DESCRIPTION OF THE PRESENTLY PREFERRED EMBODIMENTS

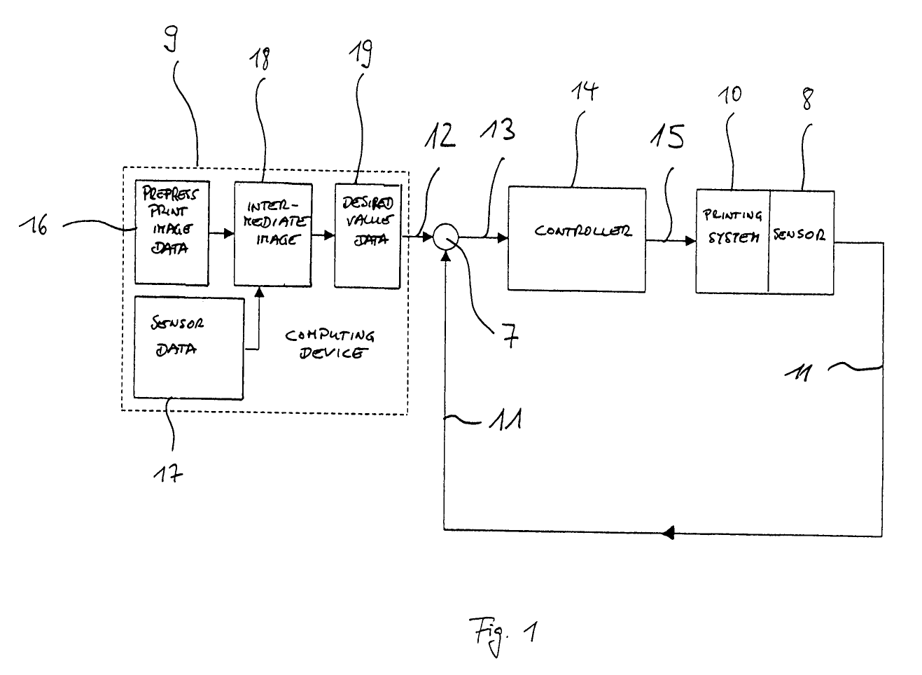

In the following, a preferred embodiment of the present invention will be described in greater detail with reference to FIG. 1.

FIG. 1 shows in schematic form the structure of a control loop to carry out the method according to the invention for controlling a printing process. The printing process can comprise, for example, cut register control, ink register control or ink density control. The controlled printing system performing the printing process is represented in FIG. 1 by block 10, wherein at least one controllable variable of the printing process is measured by at least one sensor 8 which can be integrated in the printing system 10. The sensor 8 preferably measures characteristics of the printed image and provides corresponding signal 11. This signal 11 indicates an actual characteristic value of the printed image and thus of the printing process. The sensor 8 can be, for example, a contrast sensor, a CCD line camera or CCD area camera, a CMOS line camera or CMOS area camera, or a fibre optic sensor.

The actual characteristic value is compared in a comparing device 7 with a desired characteristic value indicated by a signal 12, thereby determining a control deviation 13, the control deviation 13 being fed as input variable to a controller 14 which, on the basis of the control deviation 13 and a control regulation, generates as output variable an actuating variable 15 or actuating signal, which is used as input variable for the printing system 10 to control the printing process.

In the following, it is assumed that the control method operates mark-free, that is without the use of print control marks printed onto the product to be produced. The sensor 8 for measuring the printed product and therefore for providing the actual characteristic value accordingly measures the printed image of the printed product directly, the actual characteristic value provided in this case being compared with the desired characteristic value in form of a prepress-based desired characteristic value.

According to a preferred embodiment of the present invention, it is proposed to determine in a computing device 9 the prepress-based desired characteristic value firstly on the basis of prepress print image data 16 of the print image to be printed and secondly on the basis of data 17 including characteristics of the sensor 8 which provides the actual characteristic value the desired characteristic value is compared with. In addition to the data about the characteristics of the sensor, the data 17 can also contain data about characteristics of the printing process to be controlled, which are then likewise taken into account when providing or determining the desired characteristic value.

From the prepress print image data 16 of the print image to be printed and from the data 17 about the characteristics of the sensor and also of the printing process to be controlled, data 18 for an intermediate image are generated in the computing device 9, the volume of the data 18 of the intermediate image being reduced as compared with the prepress print image data 16 of the print image to be printed and containing only that part of the data from the prepress print image data 16 which can be determined or detected by the sensor 8.

From this reduced data 18 forming the intermediate image the computing device 9 can determine data 19 that are relevant to the control of the printing process and can be used as desired characteristic value for the control of the printing process.

The desired characteristic value for controlling the printing process is accordingly derived from prepress print image data 16 from the print image or subject to be printed, specifically while taking into account data 17 about the characteristics of the sensor 8 used and, if appropriate, about the characteristics of the printing process. The actual characteristic value provided by the sensor 8 is thus compared with a desired characteristic value adapted to the sensor 8, which value contains only that data which can be detected by the sensor 8 on the printed product during the printing process. This makes it possible to restrict the quantity of data to be handled without impairing the achievable control quality.

When determining an appropriate desired characteristic value, the characteristics of a sensor 8 that can be taken into account are a gray scale resolution, a color scale resolution, a spectral sensitivity, a geometric resolution and a measuring speed of the sensor 8. The gray scale resolution or the color scale resolution and the spectral sensitivity of the sensor 8 are taken into account when determining an appropriate desired characteristic value in that the prepress print image data 16 are filtered. On the basis of the geometric resolution of the sensor 8 and the measuring speed of the same, geometric scaling of the prepress print image data 16 can be carried out.

If the characteristic of the printing process that is taken into account is the speed of the same, geometric scaling of the prepress print image data 16 is also carried out in order to determine an appropriate desired characteristic value.

If, for example, cut register control is carried out with the aid of a sensor 8 designed as a contrast sensor (light-dark sensor), then the characteristics of the contrast sensor that are taken into account are the gray scale resolution of the contrast sensor, the size of the spot of light from the same and the spectral sensitivity of the same. On the basis of this data about the characteristics of the contrast sensor, prepress print image data 16 from the print image to be printed are then converted into data 18 for the intermediate image. As already mentioned, this is carried out by means of filtering and geometric scaling of the prepress print image data 16. For instance, if the sensor 8 used is not able to detect certain colors from the prepress print image data 16 on account of its spectral sensitivity, these spectral ranges are filtered out when generating the data 18 for the intermediate image. Furthermore, specific structural elements of a print image can be filtered out of the prepress print image data, in particular when the resolution of the sensor 8 is lower than the resolution of the prepress print image data. Depending on the measuring speed of the sensor 8 and the speed of the printing process, in the course of geometric scaling of the prepress print image data 16 the quantity of data can be reduced further, so that ultimately the data 18 from the intermediate image, from which the appropriate desired characteristic value is determined, are adapted to the receiving characteristics of the sensor 8 used.

The method according to the invention can be used in all printing processes which are to be controlled without using print control marks to be printed onto a printed product, and accordingly mark-free. In this case, the prepress print image data 16 can be adapted on the basis of the characteristics of the sensor 8 used.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling a printing process in a printing press by cut register control, ink register control or ink density control, the method comprising the steps of:
measuring a printed image with at least one sensor thereby determining at least one actual characteristic value of the printed image;
determining at least one prepress-based desired characteristic value for the printed image from prepress print image data by taking into account data indicating at least one characteristic of the at least one sensor;
comparing the at least one actual characteristic value of the printed image with the at least one prepress-based desired characteristic value, and thereby acquiring a control deviation; and
determining an actuating signal based on the control deviation for adjusting the printing process.

2. The method of claim 1, wherein the step of determining the at least one prepress-based desired characteristic value comprises converting the prepress print image data into an intermediate image based on the data indicating at least one characteristic of the at least one sensor.

3. The method of claim 2, wherein the at last one characteristic of the sensor comprises at least one of a gray scale resolution, a color scale resolution, a spectral sensitivity, a geometric resolution, and a measuring speed of the sensor.

4. The method of claim 3, wherein the step of converting comprises the step of filtering the prepress print image data corresponding to at least one of the gray scale resolution, the color scale resolution, and the spectral sensitivity of the sensor.

5. The method of claim 3, wherein the step of converting comprises the step of geometrically scaling the prepress print image data corresponding to the geometric resolution of the sensor.

6. The method of claim 3, wherein the step of determining the at least one prepress-based desired characteristic value further comprises determining the at least one prepress-based desired characteristic value from the prepress print image data by taking into account data indicating at least one characteristic of the printing process.

7. The method of claim 6, wherein the at least one characteristic of the printing process comprise a speed of the printing process.

8. The method of claim 7, wherein the step of converting comprises the step of geometrically scaling the prepress print image data corresponding to a measuring speed of the sensor and the speed of the printing process.
